(19) United States
(12) Patent Application Publication
(10) Pub. No.: US 2025/0043551 A1
(43) Pub. Date: Feb. 6, 2025

(54) DISINFECTING FAUCET ASSEMBLY

(71) Applicant: AS America, Inc., Piscataway, NJ (US)

(72) Inventor: Mahendra Gunawardena, Hillsborough, NJ (US)

(73) Assignee: AS America, Inc., Piscataway, NJ (US)

(21) Appl. No.: 18/791,612

(22) Filed: Aug. 1, 2024

Related U.S. Application Data
(60) Provisional application No. 63/530,340, filed on Aug. 2, 2023.

(51) Int. Cl. E03C 1/04; C02F 1/32

(52) U.S. Cl. CPC E03C 1/0404; C02F 1/325; C02F 2201/3225; C02F 2201/326; E03C 2201/40

(57) ABSTRACT

A disinfecting faucet assembly comprising a faucet body; a faucet spout; and a faucet spray head, wherein the faucet spray head comprises a UV light source configured to irradiate and disinfect water dispensed from the spray head. The UV light source may be positioned at or towards an outlet area of the spray head, may be positioned at or towards an inlet area of a spray head, and/or may be positioned at a side area of a spray head.

The disclosure relates to a disinfecting faucet assembly, and particularly to a faucet assembly comprising a disinfecting UV light source.

### BACKGROUND

Pathogenic microorganisms present in drinking water pose a significant threat to human health and well-being. Microorganisms, such as bacteria, spores, viruses, and fungi, including, for example, Coliforms, Salmonella, Streptococcus, Vibrio, Legionella, E. coli, Hepatitis A, Polio, Cryptosporidia, Amoeba, etc., can cause various waterborne diseases and infections if ingested. The consequence can range from mild gastrointestinal discomfort to severe illnesses and even life-threatening conditions.

Given the potential harm they can inflict, it is desirous to eliminate pathogenic microorganisms from drinking water sources. Safe and clean drinking water is a fundamental necessity for maintaining good health and promoting a high quality of life. Efficient water treatment processes and technologies play a vital role in the eradication of pathogenic microorganisms.

### SUMMARY

Accordingly, disclosed is a disinfecting faucet assembly, comprising a faucet body; a faucet spout; and a faucet spray head, wherein the faucet spray head comprises a UV light source configured to irradiate and disinfect water dispensed from the spray head. In some embodiments, a UV light source may be positioned at or towards an outlet area of the spray head. In some embodiments, a UV light source may be positioned towards or at an inlet area of a spray head. In some embodiments, a UV light source may be positioned towards or at a side of a spray head.

A spray head may comprise a disinfection chamber comprising a UV light source; an ordinary chamber; and an actuator, wherein the actuator is configured to be operated a first time to direct water flow through the ordinary chamber and to turn the UV light source off, and the actuator is configured to be operated a second time to direct water flow through the disinfection chamber and to turn UV light source on.

In other embodiments, a disinfecting faucet assembly with or without a UV light source and/or a disinfection chamber positioned in a spray head may comprise a spray head having an actuator, a multi-channel hose, a mixing valve, and a UV light disinfection chamber positioned upstream of the faucet. The actuator may be in wired electrical communication with the UV light chamber. The multi-channel hose may be fluidly coupled to the spray head at a first end, and may be fluidly coupled to a T-connector at a second end. The UV light disinfection chamber is fluidly coupled to the T-connector, the actuator is configured to be operated a first time to direct mixed hot/cold water from the mixing valve through a first channel of the multi-channel hose to the spray head and to turn the UV light chamber off, the actuator is configured to be operated a second time to direct cold source water from a cold source water inlet through the UV light disinfection chamber, through the T-connector, and through a second channel of the multi-channel hose to the spray head and to turn the UV light chamber on.

### BRIEF DESCRIPTION OF THE DRAWINGS

The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1A shows a view of a disinfecting faucet assembly, according to an embodiment.

FIG. 1B provides partial, sectional views of a disinfecting faucet assembly, according to some embodiments.

FIG. 1C provides a sectional view of a disinfecting faucet spray head, according to an embodiment.

FIG. 2 shows a disinfecting faucet assembly, according to an embodiment.

FIG. 3 shows a disinfecting faucet assembly, according to an embodiment.

FIG. 4A provides a sectional view of a disinfecting faucet spray head, according to an embodiment.

FIG. 4B illustrates a disinfecting faucet assembly, according to an embodiment.

FIG. 5A shows a disinfecting faucet assembly, according to an embodiment.

FIG. 5B and FIG. 5C each provide a sectional view of a disinfecting faucet spray head, according to some embodiments.

### DETAILED DESCRIPTION

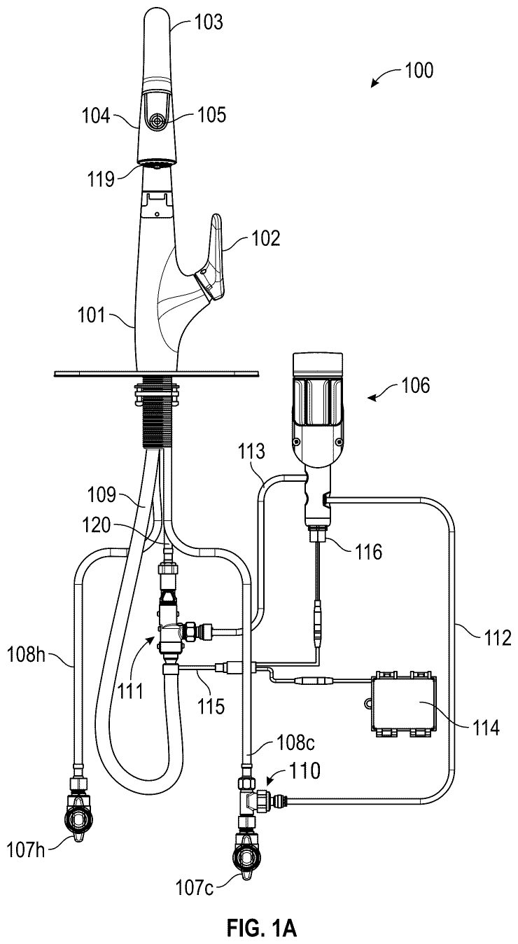

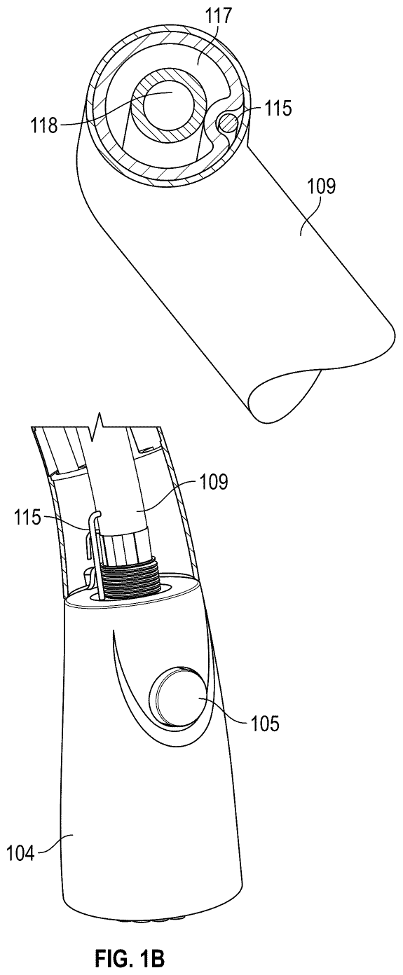

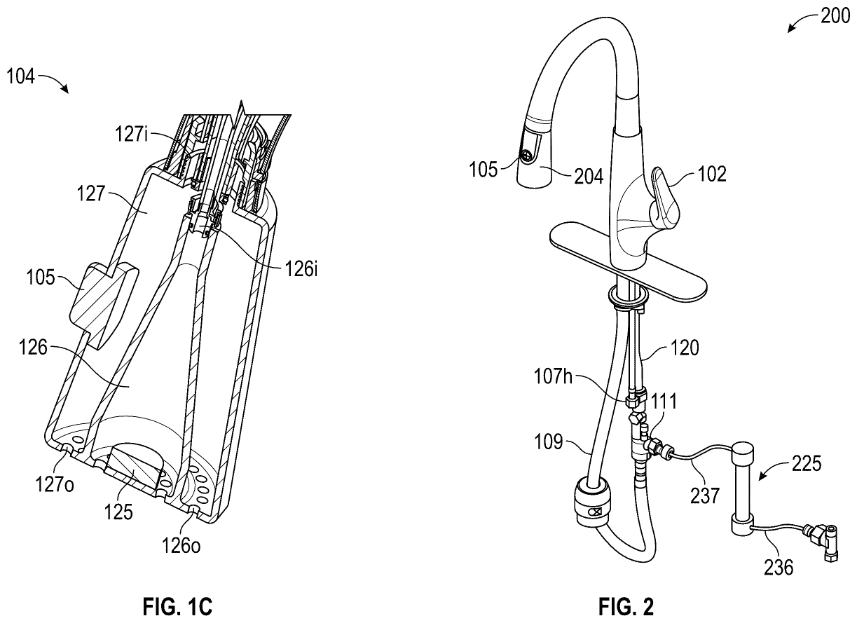

FIG. 1A provides a view of disinfecting faucet assembly 100, according to an embodiment. Faucet assembly 100 comprises faucet body 101, manual handle 102, spout 103, spray head 104, and actuator 105 positioned on spray head 104. Assembly 100 comprises cold source water inlet 107c and hot source water inlet 107h. Cold source water inlet line 108c and hot source water inlet line 108h are configured to direct water to a mixing valve positioned in faucet body 101 and associated with handle 102 (mixing valve not visible). The mixing valve is configured to deliver mixed hot/cold water to spray head 104 to be dispensed from spray face 119. A temperature and flow rate of water dispensed will depend on a position of handle 102 associated with the mixing valve. Mixed hot/cold water is configured to be directed to spray head 104 from the mixing valve, through hose 120, through T-connector 111, and through one channel of multi-channel hose 109.

Assembly 100 comprises water filter assembly 106, coupled to solenoid valve 116. Unfiltered water inlet line 112 is configured to direct unfiltered cold source water to filter assembly 106, and filtered water outlet line 113 is configured to direct filtered cold water to T-connector 111 and to a channel of multi-channel hose 109. With solenoid 116 in an off position, T-connector 110 cannot direct cold source water through filter assembly 106. When solenoid 116 is opened, cold source water will be directed through T-connector 110, through filter assembly 106, through filtered water line 113, through T-connector 111, and through a channel of multi-channel hose 109 to spray head 104. Filtered water is configured to be irradiated with a UV light source positioned in spray head 104. Faucet assembly 100 is configured to dispense filtered, UV-disinfected cold water through spray head 104. Solenoid 116 and actuator 105 are in electrical communication with battery pack 114 power source through electric wire 115.

FIG. 1B provides a partial, sectional view of multi-channel hose 109 and spray head 104, according to some embodiments. Electric cable 115 runs through multi-channel hose 109 and is electrically coupled to actuator 105, battery pack 114 and solenoid 116. Electric cable 115 is also electrically coupled to a UV light source (not visible) positioned in spray head 104. Multi-channel hose 109 comprises inner channel 118, configured to deliver filtered cold water to spray head 104. Multi-channel hose 109 also comprises outer channel 117, configured to deliver mixed hot/cold water to spray head 104 from the mixing valve positioned in body 101. Faucet assembly 100 is configured to deliver filtered/UV-disinfected cold water from spray head 104, and also to deliver unfiltered/non-disinfected mixed hot/cold water from spray head 104. Multi-channel hose 109 comprises slack, such that spray head 104 may be pulled away from spout 103, and returned to a docket position as shown in FIG. 1A.

FIG. 1C provides a sectional view of disinfecting spray head 104, according to an embodiment. Multi-channel hose 109 is configured to direct filtered water through inner channel 118 to disinfecting chamber 126. UV light source 125 is in wired electrical communication with actuator 105 (wire not shown). In an embodiment, operation of actuator 105 will open solenoid 116 to direct filtered cold water to chamber 126, and will also turn on UV light source 125 to disinfect the filtered water. Operation of actuator may cause solenoid 116 and UV light 125 to activate simultaneously, or may cause one to be activated first, followed by a brief delay to activate the other. Spray head 104 disinfecting chamber 126 is configured to receive filtered cold water from hose inner channel 118 through inlet 126i and to deliver filtered/disinfected cold water through annular outlet 126o. Chamber 126 comprises a narrow annular inlet section, and a wider annular outlet section. Spray head 104 comprises ordinary (non-disinfecting) water chamber 127, configured to receive mixed hot/cold water from the mixing valve through outer channel 117 through inlet 127i, and to deliver mixed hot/cold water through annular outlet 127o. In some embodiments, actuator 105, solenoid 116, UV light 125, and battery pack 114 may be in electrical communication with a controller (microcontroller). Upon manipulation of actuator 105, a controller may be configured to direct one of solenoid 116 and UV light 125 to be activated first, followed by a brief delay before activating the other. Actuator 105 may comprise a touch button, for example a capacitive touch button. Ordinary chamber 127 and disinfection chamber 126 are isolated and are not in flow communication. Ordinary chamber 127 encircles disinfection chamber 126.

FIG. 2 provides a view of disinfecting faucet assembly 200, according to an embodiment. In addition to, or in place of UV light 125 of FIG. 1C, assembly 200 comprises upstream UV light source 225. Assembly 200 comprises a similar arrangement as assembly 100, wherein cold source water is configured to be passed through UV light chamber 225, and through T-connector 111 to a channel of multi-channel hose 109 to spray head 204 upon operation of actuator 105. UV light source 225 or cold water line 236 may be coupled to a solenoid (not shown). Upon operation of actuator 105, cold source water is configured to be passed through UV light chamber 225 from inlet line 236, and through outlet line 237 to T-connector 111 to multi-channel hose 109. Operation of actuator 105 is also configured to turn UV chamber 225 on and off. Assembly 200 comprises hot source water inlet 107h, a separate cold source water inlet is not visible (behind mixed water outlet line 120). Spray head 204 may comprise separate chambers fluidly coupled to different channels of multi-channel hose 109, but need not have separate chambers.

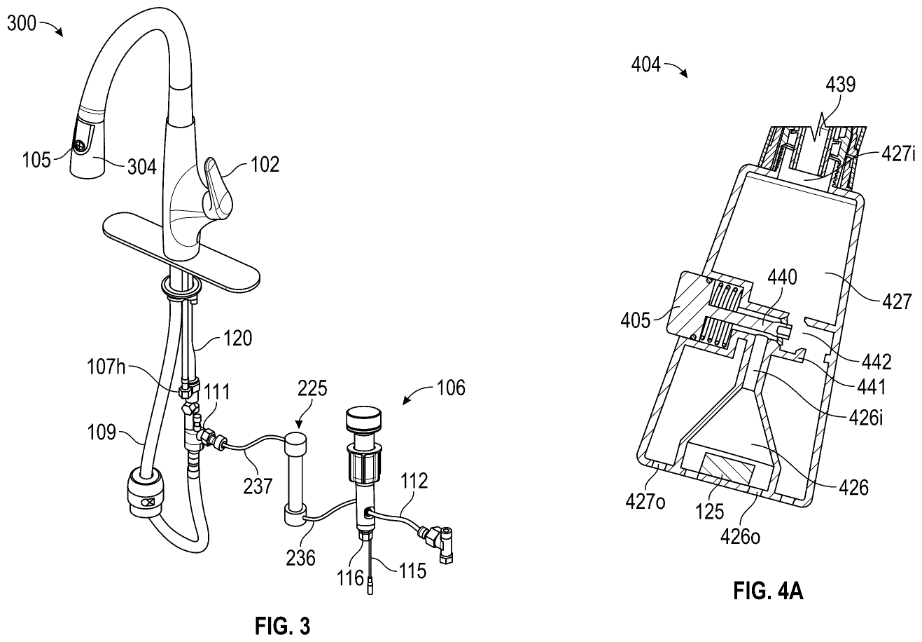

FIG. 3 provides a view of disinfecting faucet assembly 300, according to an embodiment. Assembly 300 further comprises filter assembly 106 in addition to external UV source chamber 225. Upon operation of actuator 105, solenoid 116 will be opened to allow cold source water to pass through filter assembly 106 from inlet line 112, then through line 236 through UV chamber 225, and through outlet line 237 to T-connector 111, and to a channel of multi-channel hose 109 to provide filtered, sanitized cold water to spray head 304. Assembly 300 likewise comprises a similar arrangement as assembly 100, wherein treated cold source water is configured to be directed through one channel of multi-channel hose 109 to spray head 304, and wherein mixed hot/cold water is configured to be directed through another channel of multi-channel hose 109 to spray head 304. Spray head 304 may comprise separate chambers fluidly coupled to different channels of multi-channel hose 109, but need not have separate chambers.

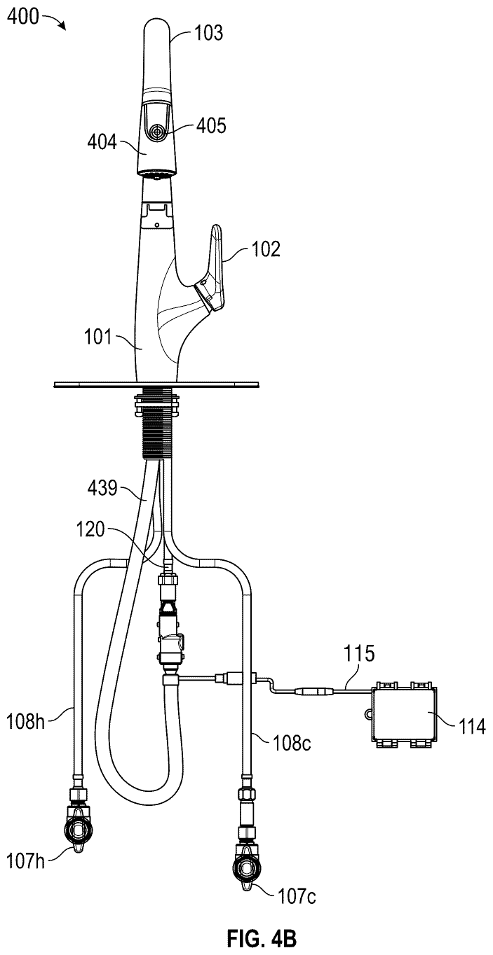

FIG. 4A shows a sectional view of disinfecting spray head 404, according to an embodiment. Water is directed to spray head 404 through single-channel hose 439. Water directed through single-channel hose 439 may be mixed hot/cold water from a mixing valve, or may be treated (e.g. filtered) cold water from a separate cold water line. Spray head 404 comprises ordinary water chamber 427 having inlet 427i and annular outlet 427o. Spray head 404 also comprises disinfecting chamber 426, comprising UV light source 125, inlet 426i, and annular outlet 426o. Actuator 405 is shown in a first position enclosing annular seat 443, such that dispensed water is configured to pass through ordinary water chamber 427 and through outlet 427o, and not through disinfection chamber inlet 426i to disinfection chamber 426. A distal end of plunger 440 is shown enclosing annular seat 443 in a first position. Actuator 405 may be manipulated (operated, touched, pushed) such that plunger 440 extends toward the right to seal annular seat 441 to close off water pathway 442 of chamber 427 in a second position. In this second position of plunger 440, water will be disallowed to pass through ordinary chamber 427, and will pass through disinfecting chamber 426 and through outlet 426o. Seat 443 and/or seat 442 may comprise a contact switch in electrical communication with UV light source 125, such that UV light 125 is activated in a plunger 440 second position, and deactivated in a plunger 440 first position. In another embodiment, spray head 404 may comprise a flow sensor in electrical communication with UV light 125 and with a power source, and configured to identify a first flow pattern wherein water is directed through ordinary chamber 427, and a second flow pattern, wherein water is directed through disinfecting chamber 426. A flow sensor may be configured to turn UV light 125 off/on accordingly. In some embodiments, a flow sensor or a contact switch may also be in electrical communication with a controller configured to direct UV light 125 to be off or on depending on a position of actuator 405. Actuator 405 may comprise a push-push mechanism or a click-pen mechanism. Ordinary chamber 427 and disinfection chamber 426 are isolated and are not in flow communication, as plunger 440 may only be in a first or a second position. Ordinary chamber 427 encircles disinfection chamber 426.

FIG. 4B provides a view of disinfecting faucet assembly 400, according to an embodiment. Spray head 404 is removably coupled to (docked at) spout 103. Single-channel hose 439 runs from a mixing valve coupled to handle 102 within body 101 (mixing valve not visible), downward, then upward through body 101 and spout 103, and is fluidly coupled to spray head 404. Cold source water is configured to pass through inlet 107c and through hose 108c to the mixing valve. Hot source water is configured to pass through inlet 107h and through hose 108h to the mixing valve. The mixing valve is configured to deliver mixed hot/cold water through hose 439 to spray head 404. A contact switch associated with plunger 440 and/or a flow sensor may be electrically coupled to power source 114 through electric wire 115. In another embodiment, faucet assembly 400 may comprise a spray head with a single chamber through which ordinary water will flow (when UV light 125 is off), and through which disinfected water will flow (when UV light 125 is on).

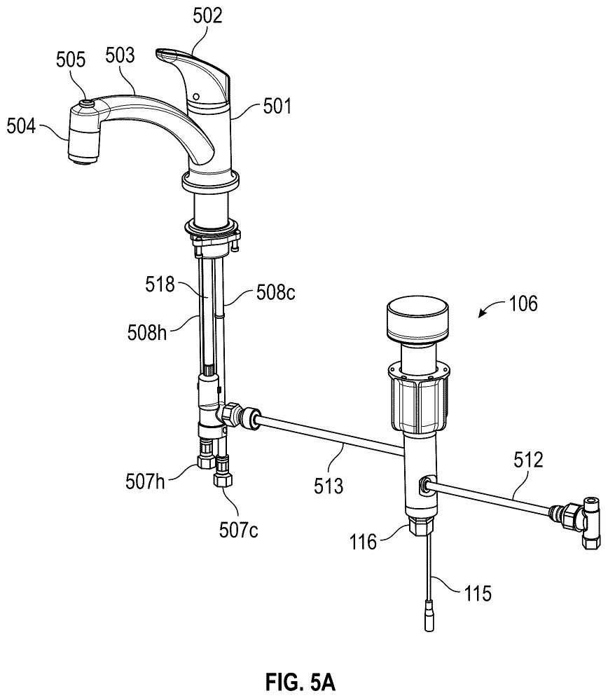

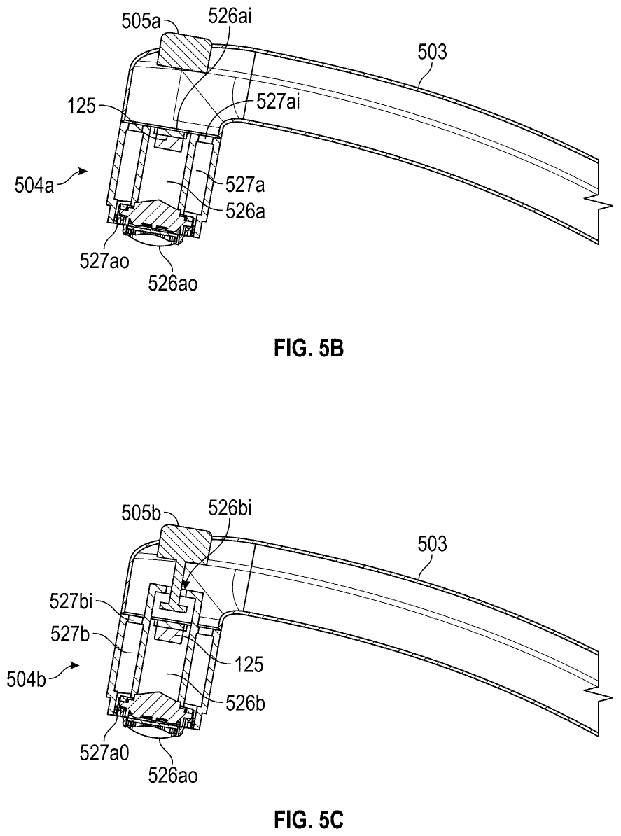

FIG. 5A shows disinfecting faucet assembly 500, according to some embodiments. Assembly 500 comprises handle 502 coupled to a mixing valve (not visible) within body 501. Faucet spray head 504 is coupled to spout 503. Cold source water inlet 507c is configured to direct cold source water through cold water hose 508c to the mixing valve, and hot source water inlet 507h is configured to direct hot source water through hot water hose 508h to the mixing valve. The mixing valve is configured to direct mixed hot/cold water through spout 503 to spray head 504. Assembly 500 also comprises cold water inlet line 512, configured to pass cold source water through filter assembly 106, through filtered water line 513, and through hose 518 separately through spout 503 to spray head 504. Spray head 504 comprises actuator 505, configured to activate a UV light source as well as filter assembly 106. Filter assembly 106 is associated with solenoid 116. Solenoid 116 is coupled to electric wire 115, which will run through body 501 and spout and will also be electrically coupled to actuator 505 and to a power source. In some embodiments, faucet assembly 500 may not have a filter assembly and may be configured to deliver unfiltered cold water through hose 518. In other embodiments, faucet assembly 500 may not have a separate cold water inlet hose 518, and may be configured to only deliver mixed hot/cold water from a mixing valve to spray head 504.

FIG. 5B provides a sectional view of disinfecting faucet spray head 504a, according to an embodiment. Filtered cold water, unfiltered cold water, or mixed hot/cold water are configured to be delivered through spout 503 to spray head 504a. Filtered cold water or separate unfiltered cold water are configured to be directed through disinfecting chamber inlet 526ai, through disinfecting chamber 526a, and out outlet 526ao. Mixed hot/cold water is configured to be delivered through spout 503 and through ordinary chamber inlet 527ai, through ordinary chamber 527a, and out outlet 527ao. UV light source 125 is configured to irradiate and disinfect water passing through chamber 526a. Actuator 505a is in wired electrical communication with UV light 125 (wire not shown). The electric wire is configured to run through spout 503 and body 501 and be coupled to a power source and optionally to solenoid 116. In an embodiment, upon touching actuator 505a, solenoid 116 is opened to direct filtered cold water, or a solenoid not associated with a filter assembly is opened to direct unfiltered cold water through hose 518, through spout 503, and to disinfecting chamber 526a. UV light 125 may be also be activated to irradiate filtered cold water or unfiltered cold water in chamber 526a upon operation of actuator 505a. UV light 125 may be activated simultaneously with solenoid 116 or another solenoid, or there may be a delay wherein UV light 125 is activated before or after activation of a solenoid. In another embodiment, wherein assembly 500 comprises no separate cold water inlet 518, touching actuator 505a a first time will direct mixed hot/cold water through disinfecting chamber 526a, and touching actuator 505a a second time will direct mixed hot cold/water through ordinary chamber 527a. Actuator 505a may be in wired electrical communication with a plunger, ceramic discs, etc. (not shown) configured to open and close a flow path so as to direct water either through chamber 526a or through chamber 527a.

FIG. 5C provides a sectional view of disinfecting faucet spray head 504b, according to an embodiment. Faucet spray head 504b comprises disinfection chamber 526b having inlet 526bi and outlet 526bo, and ordinary chamber 527b having inlet 527bi and outlet 527bo. Spray head 504b comprises actuator 505b having plunger 540. In a similar manner as for plunger 440 of FIG. 4A, plunger 540 is configured to have a first position wherein water is configured to pass through chamber 527b and not through chamber 526b. Plunger 540 is configured to have a second position wherein water is configured to pass through irradiation chamber 526b and not through ordinary chamber 527b. In some embodiments, actuator 505b may comprise a push-push mechanism or a click-pen mechanism to switch between a first and a second position. As in FIG. 4A, a position of plunger 540 may break or complete an electrical circuit by operating a contact switch in electrical communication with UV light 125. Likewise, spray head 504b may comprise a flow sensor in addition to or in place of a contact switch, and configured to identify a first water flow pattern and a second water flow pattern, and to turn UV light 125 off/on accordingly. A flow sensor or contact switch may also be configured to open and close a solenoid associated with a filter assembly or with a cold water line, simultaneously with a UV light or on a delay basis.

Suitable UV (ultraviolet) light sources include UV-LED (light emitting diode) lights, for example discrete LED, LED arrays, or combinations thereof. UV light wavelengths for disinfection include UVC light, for instance having wavelengths of from about 200 nm to about 300 nm, from about 250 nm to about 280 nm, or from about 260 nm to about 270 nm. UVC light sources are effective towards eliminate bacteria, viruses, mold, mildew, fungi, etc. In some embodiments, a UV light source may be configured to direct dosages of from any of about 0.5 mJ/cm², about 1 mJ/cm², about 3 mJ/cm², about 5 mJ/cm², about 7 mJ/cm², or about 9 mJ/cm², to any of about 11 mJ/cm², about 20 mJ/cm², about 30 mJ/cm², about 40 mJ/cm², about 50 mJ/cm², about 60 mJ/cm², about 70 mJ/cm², about 80 mJ/cm², about 90 mJ/cm², about 100 mJ/cm², or more.

In some embodiments, a UV light source may be positioned towards or at a spray head outlet. In this case, a substantial amount of UV light emitted will be directed against the flow direction of water dispensed from the spray head. In other embodiments, a UV light source may be positioned towards or at an inlet area of a spray head, so that a substantial amount of UV light emitted will be directed with the flow direction of water dispensed from the spray head. In other embodiments, one or more UV light sources may be positioned towards or at a side section of a spray head. In this case, a substantial amount of UV light will be directed in a perpendicular direction relative to water flow from the spray head.

In some embodiments, a disinfecting faucet assembly may be configured to dispense non-disinfected (ordinary) mixed hot/cold water from a mixing valve associated with a handle, upon one operating the handle, and to independently dispense disinfected cold water upon one operating an actuator positioned at a spray head. An actuator may be configured to operate a solenoid valve associated with a water filter assembly and/or with a cold water inlet. Non-disinfected (ordinary) mixed hot/cold water and disinfected water may be dispensed from separate outlets positioned at a spray head face. A temperature and flow rate of mixed hot/cold water will depend upon a position of the handle.

In another embodiment, a disinfecting faucet assembly may be configured to dispense ordinary mixed hot/cold water upon operation of a handle associated with a mixing valve, and to dispense UV-disinfected mixed hot/cold water upon operation of an actuator positioned at a spray head. In this embodiment, ordinary mixed hot/cold water and disinfected mixed hot/cold water may be dispensed from the same outlets positioned on a spray head face. Also in this embodiment, a spray head may not need separate ordinary and disinfecting chambers, and may have a single chamber through which ordinary and disinfected water flow. In this embodiment, both a handle associated with a mixing valve and an actuator on a spray head may have to be operated to dispense disinfected water.

A spray head having separate, isolated chambers for dispensing ordinary mixed hot/cold water and for dispensing disinfected cold water or disinfected mixed hot/cold water may comprise separate outlets for dispensing ordinary water and disinfected water. Outlets may be annular and may comprise a plurality of nozzles or openings. A term “isolated” may mean configured to not be in flow communication.

An actuator positioned at or on a spray head may be in wired electrical communication with a UV light source, and/or in wired electrical communication with an electrical switch and/or a flow sensor. An actuator not in wired electrical communication with a UV light source may be configured to break or complete an electric circuit such that a UV light and/or a solenoid and/or a flow sensor is activated or deactivated.

An actuator may be in electrical communication with a UV light source and a power supply. An actuator may be in electrical communication with a solenoid valve associated with a cold source water inlet or with a filter assembly.

In aspects of the disclosure, cold source water, filtered cold source water, or mixed hot/cold water may be subject to UV irradiation and disinfection. Mixed hot/cold water originates from a mixing valve, generally positioned in a faucet body and associated with a manual handle. The term “mixed hot/cold water” means any water originating from a mixing valve, full cold, full hot, and temperatures in-between. Cold water flow includes cold source water and filtered cold source water.

In some embodiments, a disinfection chamber having a UV light source positioned towards or at a spray head outlet area may comprise a shape wherein the chamber tapers from narrow at an inlet area to wider at an outlet area. In some embodiments, a spray head may comprise an indicator light configured to indicate when a UV light source is on and off. In some embodiments, a faucet assembly may comprise a controller (microcontroller) in wired electrical communication with one or more of a UV light source, a contact switch, a flow sensor, an actuator, or a solenoid. A controller may be configured to control for instance a UV dosage, a time delay between turning on a UV light and a solenoid, etc.

The term “flow communication” or “fluid communication” means for example configured for liquid or gas flow therethrough and may be synonymous with “fluidly coupled”. The terms “upstream” and “downstream” indicate a direction of gas or fluid flow, that is, gas or fluid will flow from upstream to downstream.

Likewise, “electrical communication” or “electronic communication” may mean “electrically coupled”. Electrical communication may be via wired connection or may be wireless.

The terms “coupled” or “connected” may mean that an element is “attached to” or “associated with” another element. Coupled or connected may mean directly coupled or coupled through one or more other elements. Coupled or connected may also mean permanently coupled or removably coupled. An element may be coupled to an element through two or more other elements in a sequential manner or a non-sequential manner. The term “via” in reference to “via an element” may mean “through” or “by” an element. Coupled or connected or “associated with” may also mean elements not directly or indirectly attached, but that they “go together” in that one may function together with the other.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, or ±10%. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, or ±10% of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

1. A disinfecting faucet assembly, comprising
a faucet body;
a faucet spout;
a faucet spray head comprising an actuator; and
a mixing valve,
wherein
the faucet spray head comprises a UV light source configured to irradiate and disinfect water dispensed from the spray head, and
the actuator is configured to be operated a first time to turn the UV light source off so that ordinary mixed hot/cold water can be dispensed from the spray head, and
the actuator is configured to be operated a second time to turn the UV light source on so that UV-disinfected water can be dispensed from the spray head.

2. The disinfecting faucet assembly according to claim 1, comprising a single-channel hose fluidly coupled to the mixing valve and to the spray head, wherein
the actuator is configured to be operated a first time to turn the UV light source off so that ordinary mixed hot/cold water can be dispensed from the spray head, and
the actuator is configured to be operated a second time to turn the UV light source on so that UV-disinfected mixed hot/cold water can be dispensed from the spray head.

3. The disinfecting faucet assembly according to claim 1, wherein
the spray head comprises a disinfection chamber comprising the UV light source,
the spray head comprises an ordinary chamber isolated from the disinfection chamber,
the actuator is configured to be operated a first time to direct ordinary mixed hot/cold water through the ordinary chamber and to turn the UV light source off, and
the actuator is configured to be operated a second time to direct water flow through the disinfection chamber and to turn UV light source on.

4. The disinfecting faucet assembly according to claim 3, comprising a single-channel hose, wherein
when the actuator is operated the first time, ordinary mixed hot/cold water flow is configured to be directed through the single-channel hose and through the ordinary chamber, and
when the actuator is operated the second time, water flow is configured to be directed through the single-channel hose and through the disinfection chamber.

5. The disinfecting faucet assembly according to claim 3, comprising a multi-channel hose, wherein
when the actuator is operated the first time, ordinary mixed hot/cold water flow is configured to be directed through a first channel of the multi-channel hose and through the ordinary chamber,
and
when the actuator is operated the second time, cold water flow is directed through a second channel of the multi-channel hose and through the disinfection chamber.

6. The disinfecting faucet assembly according to claim 3, wherein the actuator is in wired electrical communication with the UV light source and with a power supply.

7. The disinfecting faucet assembly according to claim 3, wherein the actuator comprises a plunger, wherein
the plunger is configured to be placed in a first position to direct water flow through the ordinary chamber and to disallow water flow through the disinfection chamber, and
the plunger is configured to be placed in a second position to direct water flow through the disinfection chamber and to disallow water flow through the ordinary chamber.

8. The disinfecting faucet assembly according to claim 7, wherein, in response to the plunger being placed in the first position or the second position, an electric circuit is broken or completed, resulting in either directing the water flow through the ordinary chamber or through the disinfection chamber.

9. The disinfecting faucet assembly according to claim 7, comprising a flow sensor, wherein the flow sensor is configured to detect if the plunger is in the first position or in the second position, and wherein the flow sensor is configured to direct the UV light source to turn off or on, respectively.

10. The disinfecting faucet assembly according to claim 3, comprising a solenoid valve associated with a cold water source, wherein when the actuator is operated the second time, the solenoid valve is opened to direct cold source water through the disinfection chamber.

11. The disinfecting faucet assembly according to claim 3, comprising a solenoid valve associated with a filter assembly, wherein when the actuator is operated the second time, the solenoid valve is opened to direct filtered cold source water through the disinfection chamber.

12. The disinfecting faucet assembly according to claim 3, wherein the ordinary chamber encircles the disinfecting chamber.

13. The disinfecting faucet assembly according to claim 3, wherein the spray head is configured to dispense mixed hot/cold water, and the mixed hot/cold water is configured to selectively be directed through the ordinary chamber or through the disinfection chamber.

14. The disinfecting faucet assembly according to claim 1, wherein the UV light source is positioned towards an outlet of the spray head.

15. The disinfecting faucet assembly according to claim 1, wherein the UV light source is positioned towards an inlet of the spray head.

16. A disinfecting faucet assembly, comprising
a faucet body;
a faucet spout;
a faucet spray head comprising an actuator;
a mixing valve;
a multi-channel hose; and
a UV light disinfection chamber,
wherein
the actuator is in wired electrical communication with the UV light chamber,
the multi-channel hose is fluidly coupled to the spray head at a first end, and is fluidly coupled to a T-connector at a second end,
the UV light disinfection chamber is fluidly coupled to the T-connector,
the actuator is configured to be operated a first time to turn the UV light chamber off so that mixed hot/cold water from the mixing valve can be directed through a first channel of the multi-channel hose to the spray head, and
the actuator is configured to be operated a second time to turn the UV light chamber on and to direct cold source water from a cold source water inlet through the UV light disinfection chamber, through the T-connector, and through a second channel of the multi-channel hose to the spray head.

17. The disinfecting faucet assembly according to claim 16, wherein the UV light disinfection chamber or the cold source water inlet is associated with a solenoid valve electrically coupled to the actuator.

18. The disinfecting faucet assembly according to claim 16, wherein the UV light disinfection chamber is in flow communication with a filter assembly, and wherein the UV light disinfection chamber and the filter assembly are positioned upstream of the T-connector.

19. The disinfecting faucet assembly according to claim 18, wherein the filter assembly is fluidly coupled to a solenoid valve electrically coupled to the actuator.

20. The disinfecting faucet assembly according to claim 16, wherein the spray head comprises a UV light source positioned at a spray head interior.
